(19) United States
(12) Patent Application Publication
(10) Pub. No.: US 2026/0109154 A1
(43) Pub. Date: Apr. 23, 2026

(54) PRINTING APPARATUS AND PRINTING METHOD

(71) Applicant: SEIKO EPSON CORPORATION, Tokyo (JP)

(72) Inventor: Kohei MARUYAMA, SHIOJIRI-SHI (JP)

(21) Appl. No.: 19/362,903

(22) Filed: Oct. 20, 2025

(30) Foreign Application Priority Data
Oct. 21, 2024 (JP) 2024-184805

(51) Int. Cl. B41J 2/21

(52) U.S. Cl. CPC B41J 2/2135; B41J 2/2114; B41J 2/2139; B41J 2/2142

(57) ABSTRACT

A print controller in a printing apparatus according to the present disclosure performs control of executing at least one of printing of a first test pattern for adjusting landing positions on a medium of first ink and printing of a second test pattern for adjusting landing positions on the medium of second ink lower in visibility than the first ink. The first test pattern includes a plurality of patterns to be printed with a setting value of an adjustment item for adjusting the landing position of the first ink changed by a first amount of change, and the second test pattern includes a plurality of patterns to be printed with a setting value of the adjustment item for adjusting the landing position of the second ink changed by a second amount of change. The second amount of change is larger than the first amount of change.

The present application is based on, and claims priority from JP Application Serial Number 2024-184805, filed October 21, 2024, the disclosure of which is hereby incorporated by reference herein in its entirety.

### BACKGROUND

### 1. Technical Field

The present disclosure relates to a printing apparatus and a printing method.

### 2. Related Art

There is known a technique of printing an image on a medium by ejecting not only color ink but also functional liquid having a predetermined function for assisting formation of an image with the color ink. In this regard, JP-A-10-230627 discloses a technique of suppressing bleeding of the ink and improving the water resistance of a recorded object by ejecting, to the medium, a treatment liquid that insolubilizes a dye in the ink. Further, this document also discloses that such a treatment liquid is transparent, and therefore, it is difficult to visually confirm a density pattern which is a test pattern for determining an ejection failure or the like.

JP-A-10-230627 is an example of the related art.

As described in the above document, when the liquid to be ejected is a liquid having low visibility, it is not easy to perform the confirmation using the test pattern. In particular, in this case, it is not easy to adjust the landing positions of the liquid on the medium using the test pattern. Therefore, it is required to provide a technique capable of easily adjusting the landing positions of the liquid having low visibility.

### SUMMARY

A printing apparatus according to the present disclosure includes a print head unit including a plurality of first nozzles configured to eject first ink to a medium and a plurality of second nozzles configured to eject, to the medium, second ink lower in visibility than the first ink, and a print controller configured to control printing using the print head unit, wherein the print controller controls execution of at least one of printing of a first test pattern used for adjusting a landing position on the medium of the first ink ejected from the first nozzle, and printing of a second test pattern used for adjusting a landing position on the medium of the second ink ejected from the second nozzle, the first test pattern includes a plurality of patterns to be printed with a setting value of an adjustment item for adjusting the landing position of the first ink changed by a first amount of change, the second test pattern includes a plurality of patterns to be printed with a setting value of an adjustment item for adjusting the landing position of the second ink changed by a second amount of change, and the second amount of change is larger than the first amount of change.

A printing method executed by a printing apparatus including a print head unit including a plurality of first nozzles configured to eject first ink to a medium and a plurality of second nozzles configured to eject, to the medium, second ink lower in visibility than the first ink includes performing printing of a test pattern including at least one of printing of a first test pattern used for adjusting a landing position on the medium of the first ink ejected from the first nozzle, and printing of a second test pattern used for adjusting a landing position on the medium of the second ink ejected from the second nozzle, wherein the first test pattern includes a plurality of patterns to be printed with a setting value of an adjustment item for adjusting the landing position of the first ink changed by a first amount of change, the second test pattern includes a plurality of patterns to be printed with a setting value of an adjustment item for adjusting the landing position of the second ink changed by a second amount of change, and the second amount of change is larger than the first amount of change.

### BRIEF DESCRIPTION OF THE DRAWINGS

FIG. 1 is a schematic diagram showing a schematic configuration of a printing apparatus according to an embodiment.

FIG. 2 is a schematic diagram showing a head unit.

FIG. 3 is a table showing liquids to be ejected from respective liquid ejection heads.

FIG. 4 is a block diagram showing a configuration example of a controller according to Embodiment 1.

FIG. 5 is a schematic diagram showing an example of a first test pattern.

FIG. 6 is a schematic diagram showing a configuration of a partial pattern contained in a test pattern.

FIG. 7 is a schematic diagram showing an example of a second test pattern.

FIG. 8 is a schematic diagram showing another example of the second test pattern.

FIG. 9 is a flowchart showing an example of a flow of an operation of the printing apparatus according to Embodiment 1.

FIG. 10 is a block diagram showing a configuration example of a controller according to Embodiment 2.

FIG. 11 is a flowchart showing an example of a flow of an operation of the printing apparatus according to Embodiment 2.

FIG. 12 is a schematic diagram showing an example of a test pattern for adjusting the landing positions of ink in a conveyance direction of a medium.

### DESCRIPTION OF EMBODIMENTS

Some embodiments will hereinafter be described with reference to the drawings. In order to clarify the description, the following description and drawings are omitted and simplified as appropriate. Further, in the drawings, the same elements are denoted by the same reference numerals and redundant descriptions will be omitted as needed. Further, in the drawings, X, Y, and Z respectively represent three spatial axes perpendicular to each other. In the present specification, directions along these axes are referred to as an X direction, a Y direction, and a Z direction, respectively. In the following description, a direction of an arrow is a positive (+) direction and a direction opposite to the arrow is a negative (-) direction in each drawing. In addition, directions of three spatial axes in which the positive direction and the negative direction are not limited will be described as an X-axis direction, a Y-axis direction, and a Z-axis direction.

### Embodiment 1

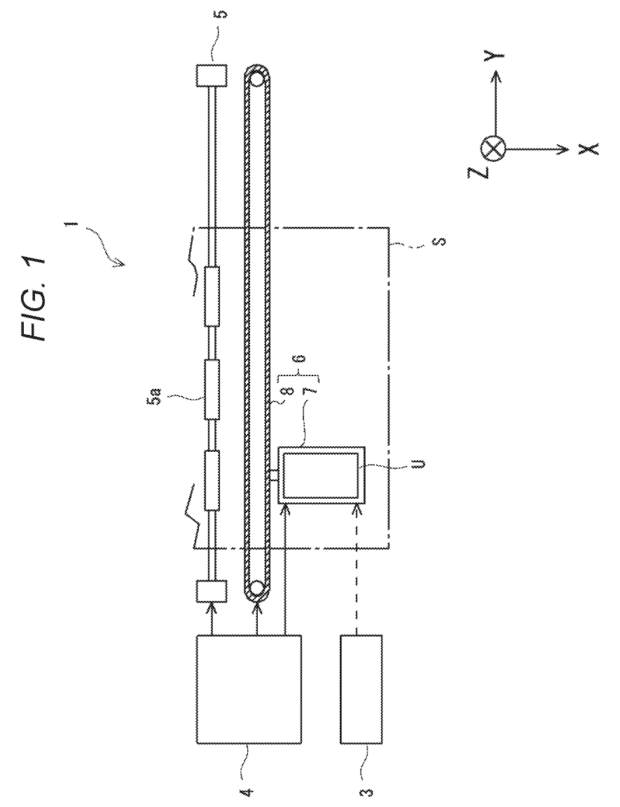

FIG. 1 is a diagram showing a schematic configuration of a printing apparatus 1 according to Embodiment 1. As illustrated in FIG. 1, the printing apparatus 1 is a so-called serial printer which includes a head unit U for ejecting a liquid, and performs printing by ejecting a liquid in the +Z direction from the head unit U toward the medium S while conveying a medium S in the X-axis direction, and reciprocating the head unit U in the Y-axis direction. The head unit U is a specific example of a print head unit. Note that in the present embodiment, the medium S is, for example, fabric. Therefore, the printing apparatus 1 is a textile printer that performs printing on fabric. However, as the medium S, any material such as recording paper or a resin film can be used in addition to fabric. Further, the liquid to be ejected by the printing apparatus 1 is generally classified into color ink containing a color material and a functional liquid. The color ink is a colored liquid having some color material such as a dye or a pigment. The functional liquid is also referred to as a functional ink. Here, the functional liquid refers to a colorless liquid (a transparent liquid) having a predetermined function for assisting formation of an image with the color ink. More specifically, the functional liquid is a liquid that reacts with the color ink to improve the quality of the image to be formed on the medium compared to when the functional liquid is not used. In the present embodiment, as an example, the head unit U ejects a penetrant that is a functional liquid having a function of promoting permeation of the color ink into the medium S.

Such a printing apparatus 1 includes a head unit U, a liquid storage unit 3, a controller 4, a conveyance mechanism 5 that feeds the medium S, and a moving mechanism 6.

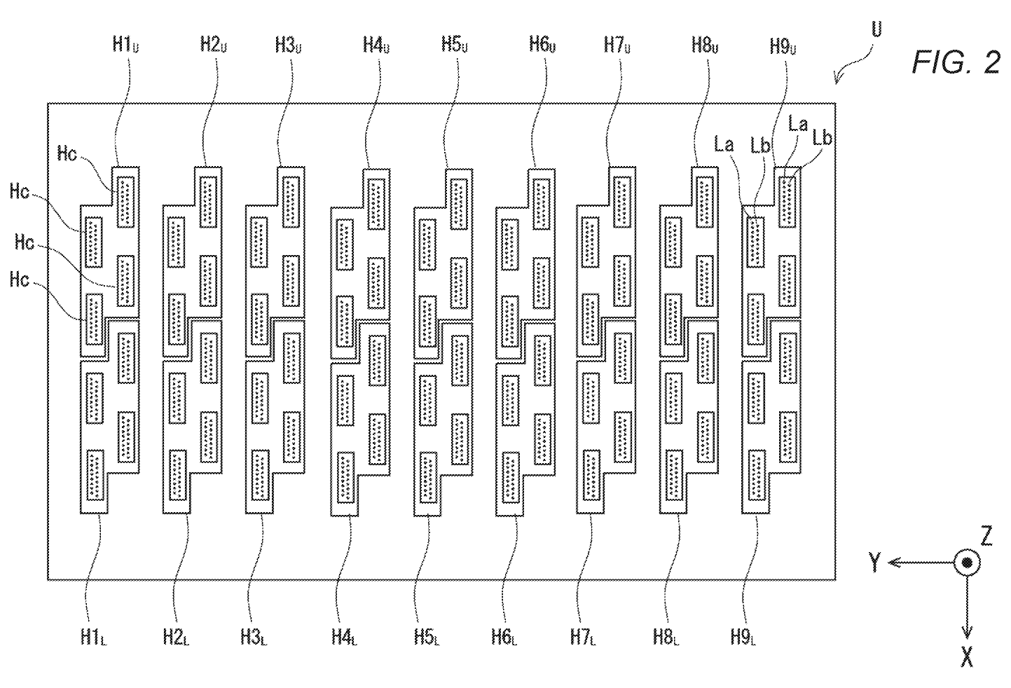

As illustrated in FIG. 2, the head unit U includes a plurality of liquid ejection heads H1_{U} to H9_{U} and H1_{L} to H9_{L}. Hereinafter, these liquid ejection heads are simply referred to as liquid ejection heads H when not particularly distinguished from each other. The number and arrangement of the liquid ejection heads H provided to the head unit U are illustrative only, and any configuration can be adopted as the configuration of the head unit U.

The liquid ejection head H ejects, in the +Z direction as droplets, the liquid supplied from the liquid storage unit 3 that stores the liquid. The liquid storage unit 3 individually stores a plurality of types of liquids different in color or component to be ejected from the liquid ejection head H.

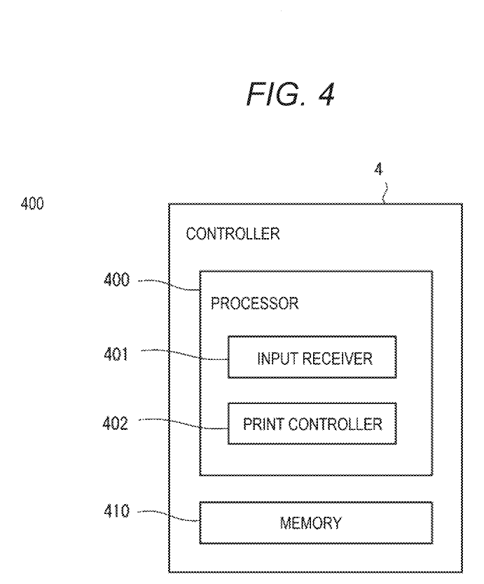

As shown in FIG. 4, the controller 4 is, for example, a computer including a processor 400 and a memory 410. The controller 4 is electrically coupled to the liquid ejection head H and so on via external wiring (not illustrated). The controller 4 generally controls each of the elements of the printing apparatus 1, that is, the liquid ejection head H, the conveyance mechanism 5, the moving mechanism 6, and so on in accordance with print image data acquired from an external apparatus such as a personal computer.

The conveyance mechanism 5 is for conveying the medium S in the X-axis direction, and includes a conveyance roller 5a. That is, the conveyance mechanism 5 conveys the medium S in the X-axis direction by rotating the conveyance roller 5a. The conveyance roller 5a is rotated by drive of a conveyance motor (not illustrated). The controller 4 controls the conveyance of the medium S by controlling the drive of the conveyance motor. Note that the conveyance mechanism 5 that conveys the medium S is not limited to one including the conveyance roller 5a, and may be, for example, one that conveys the medium S by a belt or a drum.

The moving mechanism 6 is a mechanism for reciprocating the head unit U in the Y-axis direction, and includes a carriage 7 and a conveyance belt 8. The carriage 7 holds the head unit U. The carriage 7 is fixed to the conveyance belt 8. The conveyance belt 8 is an endless belt suspended along the Y-axis direction. The conveyance belt 8 is rotated by drive of a conveyance motor (not illustrated). The controller 4 rotates the conveyance belt 8 by controlling the drive of the conveyance motor to reciprocate the head unit U in the Y-axis direction together with the carriage 7. Note that the carriage 7 may have a configuration of mounting the liquid storage unit 3 together with the liquid ejection head H.

The plurality of liquid ejection heads H mounted on the head unit U executes, under the control of the controller 4, an ejection operation of ejecting the liquid supplied from the liquid storage unit 3 from each of the plurality of nozzles as droplets in the +Z direction. The ejection operation by the liquid ejection heads H is performed in parallel to the conveyance of the medium S by the conveyance mechanism 5 and the reciprocating movement of the liquid ejection heads H by the moving mechanism 6, and thus so-called printing in which the liquid is applied to the medium S to form an image on the medium S is performed.

In the present embodiment, so-called bidirectional printing is performed as an example. Moving the head unit U once in the Y-axis direction is hereinafter referred to as one pass. In the bidirectional printing, the printing apparatus 1 executes +Y-direction print processing of ejecting the liquid while moving the head unit U in the +Y direction to form the partial image by a bandwidth corresponding to a first pass on the medium S. Then, the printing apparatus 1 executes movement processing of moving the medium S in the X-axis direction by the bandwidth, and then executes -Y-direction print processing of forming a partial image by the bandwidth corresponding to a second pass on the medium S by ejecting the liquid while moving the head unit U in the -Y direction. Thereafter, the printing apparatus 1 repeats the +Y-direction print processing and the -Y-direction print processing until an image is formed on the medium S. Note that in the bidirectional printing, the movement processing may be performed after the +Y-direction print processing and the -Y-direction print processing are executed, or the movement processing may be performed after both the +Y-direction print processing and the -Y-direction print processing are executed a plurality of times.

Then, a configuration example of the head unit U will be specifically described. FIG. 2 is a schematic diagram of the head unit U viewed in the -Z direction. Note that the directions of the head unit U will be described based on the directions when the head unit U is mounted on the printing apparatus 1, that is, the X-axis direction, the Y-axis direction, and the Z-axis direction.

In the head unit U, pairs of liquid ejection heads each including two liquid ejection heads H arranged along the X axis are arranged side by side at a predetermined interval along the Y axis. Note that in FIG. 2, the liquid ejection heads H located at an upper part of the head unit U are sequentially referred to as liquid ejection heads H1_{U} to H9_{U} toward the -Y direction, and the liquid ejection heads H located at a lower part of the head unit U are sequentially referred to as liquid ejection heads H1_{L} to H9_{L} toward the -Y direction. Therefore, in FIG. 2, for example, the liquid ejection head H1_{U} and the liquid ejection head H1_{L} constitute the pair of the liquid ejection heads described above.

In the configuration illustrated in FIG. 2, each of the liquid ejection heads H includes four head chips Hc arranged in a staggered manner along the X-axis direction. Here, the expression that a plurality of head chips Hc is arranged in a staggered manner along the X-axis direction means that the head chips Hc arranged side by side in the X-axis direction are alternately shifted in the Y-axis direction. That is, two rows each having the head chips Hc arranged along the X axis are arranged side by side along the Y axis, and the two head chips Hc rows are disposed so as to be shifted in the X-axis direction. By arranging the plurality of head chips Hc in a staggered manner along the X-axis direction in such a manner, the nozzle arrays of the two head chips Hc are partially overlapped in the X-axis direction, and a continuous array of the nozzles is formed over the X-axis direction.

The head chip Hc is provided with two nozzle arrays capable of ejecting the liquid. The nozzle arrays are arranged in a row along the X-axis direction. The nozzle arrays are arranged apart from each other in the Y-axis direction. In FIG. 2, the two nozzle arrays are referred to as a nozzle array La and a nozzle array Lb in order toward the -Y direction. The nozzle arrays La, Lb are arranged so as to be shifted from each other in the X-axis direction by a half the pitch of the nozzles, a so-called half pitch. That is, the nozzles constituting the nozzle array La and the nozzle array Lb are arranged in a staggered manner along the X-axis direction.

In the present embodiment, as an example, one nozzle array La in each of the four head chips Hc belonging to one liquid ejection head H ejects the same type of liquid, and the other nozzle array Lb of each of the four head chips Hc belonging to one liquid ejection head H ejects the same type of liquid different from the liquid ejected by the nozzle array La.

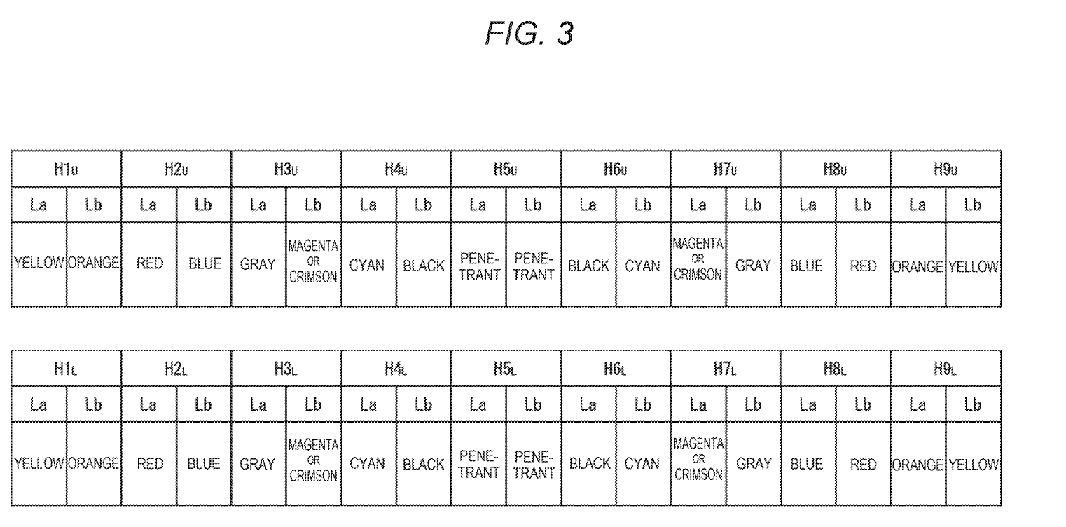

FIG. 3 is a table showing the liquids ejected from the respective liquid ejection heads H. Note that since combinations of the two types of liquids respectively ejected by the four head chips Hc belonging to one liquid ejection head H are all the same, the description of each of the head chips Hc is omitted in the table illustrated in FIG. 3. As illustrated in FIG. 3, the following liquids are ejected from the respective liquid ejection heads H.

In the liquid ejection head H1_{U} and the liquid ejection head H1_{L}, each of the nozzle arrays La ejects yellow ink, and each of the nozzle arrays Lb ejects orange ink.

In the liquid ejection head H2_{U} and the liquid ejection head H2_{L}, each of the nozzle array La ejects red ink, and each of the nozzle arrays Lb ejects blue ink.

In the liquid ejection head H3_{U} and the liquid ejection head H3_{L}, each of the nozzle arrays La ejects gray ink, and each of the nozzle arrays Lb ejects magenta ink or crimson ink.

In the liquid ejection head H4_{U} and the liquid ejection head H4_{L}, each of the nozzle arrays La ejects the cyan ink, and each of the nozzle arrays Lb ejects the black ink.

In the liquid ejection head H5_{U} and the liquid ejection head H5_{L}, each of the nozzle arrays La and each of the nozzle arrays Lb eject the penetrant, which is a functional liquid.

In the liquid ejection head H6_{U} and the liquid ejection head H6_{L}, each of the nozzle arrays La ejects the black ink, and each of the nozzle arrays Lb ejects the cyan ink.

In the liquid ejection head H7_{U} and the liquid ejection head H7_{L}, each of the nozzle arrays La ejects magenta ink or crimson ink, and each of the nozzle arrays Lb ejects the gray ink.

In the liquid ejection head H8_{U} and the liquid ejection head H8_{L}, each of the nozzle arrays La ejects the blue ink, and each of the nozzle arrays Lb ejects the red ink.

In the liquid ejection head H9_{U} and the liquid ejection head H9_{L}, each of the nozzle arrays La ejects the orange ink, and each of the nozzle arrays Lb ejects the yellow ink.

As described above, in the present embodiment, the nozzle arrays that eject the penetrant are disposed at the center in the Y-axis direction, and the types of liquids to be ejected from the nozzle arrays have a line-symmetrical relationship with respect to the X axis as the axis of symmetry. Note that these are illustrative only, and the types of liquids to be ejected from the respective liquid ejection heads H are not limited to the combinations described above.

Incidentally, since the deviation of the landing positions of the ejected liquid on the medium S affects the quality of the image formed on the medium S, the landing positions of the ejected liquid on the medium S need to be appropriately adjusted. Therefore, in order to adjust the landing position, in the present embodiment, the printing apparatus 1 prints the test pattern. Hereinafter, processing related to printing of the test pattern for adjusting the landing positions will be specifically described.

FIG. 4 is a block diagram illustrating a configuration example of the controller 4 focusing attention on the processing related to the adjustment of the landing position. As shown in FIG. 4, the controller 4 includes a processor 400 and a memory 410. As described above, the controller 4 has a function as a computer.

The memory 410 is configured with, for example, a combination of a volatile memory and a nonvolatile memory. The memory 410 is used to store a program to be executed by the processor 400 and data and so on to be used for various types of processing.

The processor 400 reads the program from the memory 410 and executes the program. As a result, the processor 400 implements the functions of an input receiver 401 and a print controller 402 described later. The processor 400 may be, for example, a microprocessor, a microprocessor unit (MPU), or a central processing unit (CPU). The processor 400 may include a plurality of processors.

The input receiver 401 receives an input from a user. The input receiver 401 may receive an input for selecting which of landing positions of first ink and second ink described later is to be adjusted. Further, the input receiver 401 may receive an input for determining a setting value for controlling the landing positions of the ink. The input receiver 401 receives the input by the user via any input devices. The input device may be a terminal apparatus communicably coupled to the printing apparatus 1, such as a smartphone, a tablet, or a personal computer. Further, the input device may be an operation panel or the like provided to the printing apparatus 1.

The print controller 402 performs various types of control related to printing. That is, the print controller 402 controls printing to be performed using the head unit U. The head unit U includes a plurality of first nozzles capable of ejecting the first ink to the medium S and a plurality of second nozzles capable of ejecting the second ink having lower visibility than the first ink to the medium S. In the present embodiment, the color ink corresponds to the first ink described above, and the nozzles constituting the nozzle array La that ejects the color ink or the nozzle array Lb that ejects the color ink correspond to the first nozzles described above. Further, a transparent penetrant corresponds to the second ink described above, and the nozzles constituting the nozzle array La that ejects the penetrant or the nozzle array Lb that ejects the penetrant correspond to the second nozzles described above. Hereinafter, the first ink is also referred to as high-visibility ink, and the second ink is also referred to as low-visibility ink. Note that the first ink (the high-visibility ink) may be defined as a liquid having a color, the color difference of which from a color of the medium S on which a test pattern described later is to be printed is equal to or greater than a predetermined threshold value. Similarly, the second ink (the low-visibility ink) may be defined as a liquid having a color, the color difference of which from the color of the medium S on which the test pattern described later is to be printed is less than the predetermined threshold value. Note that the liquids having colors whose a color difference from the color of the medium S is less than the predetermined threshold value include a colorless liquid.

In the present embodiment, the print controller 402 executes control of printing the test pattern used for adjusting the positional relationship between the landing positions of the liquid in the +Y-direction print processing and the landing positions of the liquid in the -Y-direction print processing in the bidirectional printing. Specifically, the print controller 402 performs control to print one of a first test pattern and a second test pattern described later on the medium S. The color of the medium S on which the test pattern is to be printed is, for example, white.

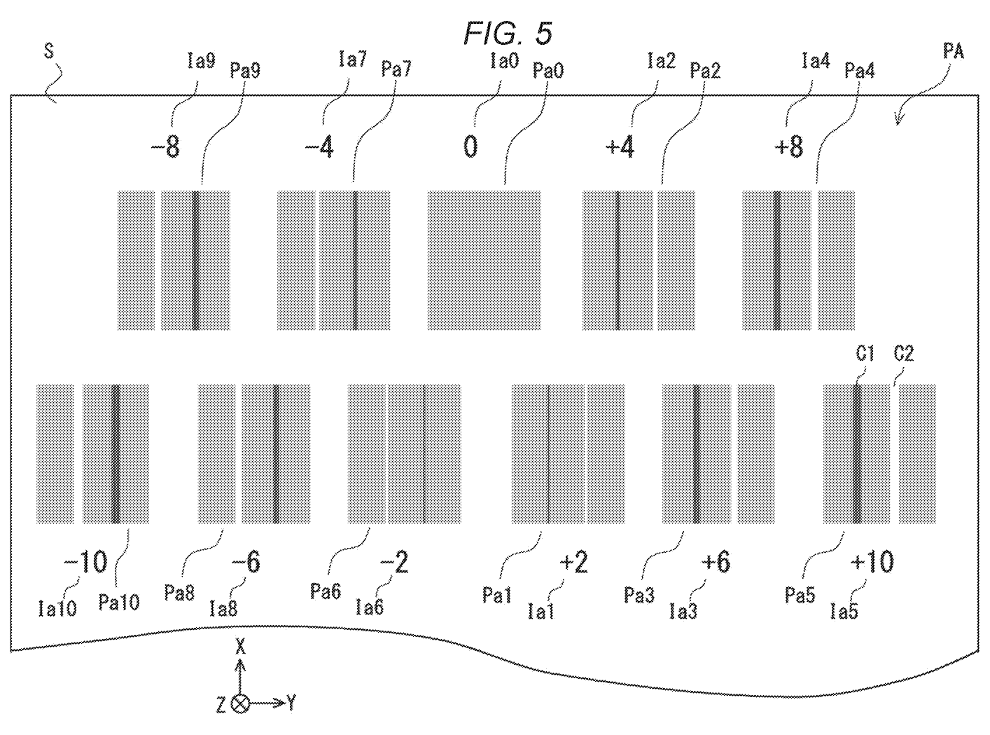

FIG. 5 is a schematic diagram illustrating an example of the first test pattern which is a test pattern used for adjusting the landing positions with respect to the first ink (the high-visibility ink) described above. The print controller 402 controls printing of the first test pattern PA used for adjusting the landing positions of the first ink ejected from the first nozzles on the medium S. As shown in FIG. 5, the first test pattern PA includes a plurality of patterns Pa0 to Pa10. Hereinafter, the patterns Pa0 to Pa10 are each referred to as a pattern Pax when not particularly distinguished from each other. Note that the pattern Pax may be referred to as a partial pattern. In FIG. 5, as an example, the first test pattern PA includes 11 patterns Pax, but the first test pattern PA is only required to include a plurality of patterns Pax, and the number of patterns Pax is not limited to 11. In the first test pattern PA, the patterns Pax are arranged apart from each other. The first test pattern PA also includes index values Ia0 to Ia10 representing how much a setting value used for printing each of the patterns Pax deviates from a predetermined reference value. That is, the index values Ia0 to Ia10 each represent a degree of an amount of change from the predetermined reference value for the setting value used. The patterns Pa0 to Pa10 are patterns to be printed with the setting value of an adjustment item for adjusting the landing positions of the first ink changed by a first amount of change. That is, the patterns Pax are printed using respective values different from each other as the setting value of the adjustment item for adjusting the landing positions. Hereinafter, the index values Ia0 to Ia10 are each referred to as index value Iax when not particularly distinguished from each other. The index value Iax corresponding to the pattern Pax is printed near the pattern Pax. Specifically, in FIG. 5, as an example, the index value Iax is arranged above or below the pattern Pax.

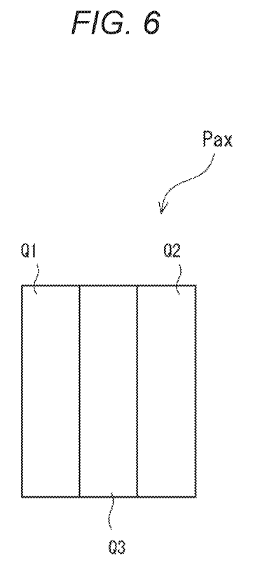

FIG. 6 is a schematic diagram illustrating a configuration of a partial pattern contained in the test pattern. As illustrated in FIG. 6, the partial pattern, that is, the pattern Pax includes a first patch Q1, a second patch Q2, and a third patch Q3. Here, in the present embodiment, as an example, the first patch Q1 and the second patch Q2 are printed on the medium S in the +Y-direction print processing in the bidirectional printing, and the third patch Q3 is printed on the medium S in the -Y-direction print processing in the bidirectional printing. However, conversely, the first patch Q1 and the second patch Q2 may be printed on the medium S in the -Y-direction print processing, and the third patch Q3 may be printed on the medium S in the +Y-direction print processing. The print controller 402 changes the setting value used when printing the third patch Q3 by the partial pattern. As a result, the position of the third patch Q3 is shifted in the Y-axis direction. An appropriate setting value is a setting value with which printing in which the third patch Q3 is disposed at the center of a gap between the first patch Q1 and the second patch Q2 is realized as in the pattern Pa0 illustrated in FIG. 5. Specifically, the print controller 402 may print a plurality of partial patterns on the medium S with ejection timing of the liquid for printing the third patch Q3 changed by the first amount of change, or may print a plurality of partial patterns on the medium S with a moving speed of the head unit U when printing the third patch Q3 changed by the first amount of change. That is, the setting value of the adjustment item for adjusting the landing positions may be a setting value used for adjusting the ejection timing or a setting value used for adjusting the moving speed of the head unit U (carriage 7). Note that instead of the third patch Q3, the positions of the first patch Q1 and the second patch Q2 may be shifted by the partial pattern.

As illustrated in FIG. 5, the plurality of patterns Pax different in position of the third patch Q3 from each other are printed as the first test pattern PA by the control described above of the print controller 402. When the value of the setting value is not appropriate, the position of the third patch Q3 deviates from the center of the gap between the first patch Q1 and the second patch Q2 as a result. Therefore, as shown in the patterns Pa1 to Pa10, an overlap region C1 as a region in which the third patch Q3 overlaps the first patch Q1 or the second patch Q2 and which is printed darkly, and a blank region C2 as a gap between the third patch Q3 and the first patch Q1 or the second patch Q2, are formed on the medium S. As illustrated in the patterns Pa1 to Pa10, the widths of the overlap region C1 and the blank region C2 in the Y-axis direction are different between the patterns Pax.

As described above, the index value Iax represents the degree of the amount of change from the predetermined reference value for the setting value used for printing the pattern Pax. More specifically, the index value Iax represents the number of times as large as a predetermined unit amount the amount of change in the setting value from the predetermined reference value is. Here, the unit amount used for the index value Iax is an amount of change in the setting value with which the landing positions of the liquid are changed by a predetermined first distance (e.g., 42 μm). As shown in FIG. 5, the first test pattern PA includes a plurality of patterns Pax having the index values Iax different by two. Therefore, every time the index value Iax increases by two, the landing positions of the liquid are displaced in the +Y direction by twice as large as the predetermined first distance as a result. Similarly, every time the index value Iax decreases by two, the landing positions of the liquid are displaced in the -Y direction by twice as large as the predetermined first distance. Therefore, it can be said that the first test pattern PA includes a plurality of patterns to be printed while shifting the landing positions of the first ink by a first shift amount (specifically, twice as large as the first distance). More specifically, it can be said that the first test pattern PA includes a plurality of patterns printed while shifting the landing positions of the first ink by the first shift amount (specifically, twice as large as the first distance) with respect to some patches (e.g., the third patch Q3 in FIG. 6).

In the example illustrated in FIG. 5, some partial patterns of the first test pattern PA are printed in an upper part, and the other partial patterns are printed in a lower part, but the partial patterns are not necessarily printed in a plurality of parts. However, as illustrated in FIG. 5, it is preferable that the partial patterns are arranged such that the index values (the setting values) corresponding thereto are in an ascending or descending order.

When performing the adjustment of the landing positions of the first ink (the high-visibility ink), for example, the user visually observes the printing result of the first test pattern as illustrated in FIG. 5 and instructs an appropriate setting value to the printing apparatus 1. Specifically, the user identifies an index value that enables printing in which the position of the third patch Q3 is located at the center of the gap between the first patch Q1 and the second patch Q2 based on the printing result of the first test pattern. Then, the user instructs the printing apparatus 1 to execute printing with the setting value corresponding to the specified index value. In this way, the adjustment of the setting value used when ejecting the first ink is achieved. More specifically, in the present embodiment, as an example, the setting value for the ejection of the first ink in the -Y-direction print processing is adjusted. Note that in the example illustrated in FIG. 5, appropriate printing is realized in the pattern Pa0 in which the index value is "0”, but obviously, such a result is not necessarily obtained. That is the appropriate printing may be realized in, for example, the pattern Pa2 in which the index value is "+4”, or the pattern Pa8 in which the index value is "-6”. In addition, an intermediate partial pattern between two partial patterns printed as the first test pattern PA may correspond to appropriate printing. For example, an intermediate value between the setting value of the pattern Pa2 and the setting value of the pattern Pa3 may realize the appropriate printing. Therefore, the index value identified based on the printing result of the first test pattern for determining the setting value is only required to be a value of an integral multiple of the unit amount described above, and may be an index value not printed in the test pattern. For example, in the example described above, the index value identified based on the printing result of the first test pattern is "+5”. That is, the setting value can be adjusted in units of the unit amount used for the index values Iax. As described above, the unit amount used for the index value Iax is the amount of change in the setting value with which the landing positions of the liquid are changed by the predetermined first distance. Therefore, in the present embodiment, the setting value for the first ink is determined using the predetermined first distance as a unit of adjustment of the landing positions of the first ink.

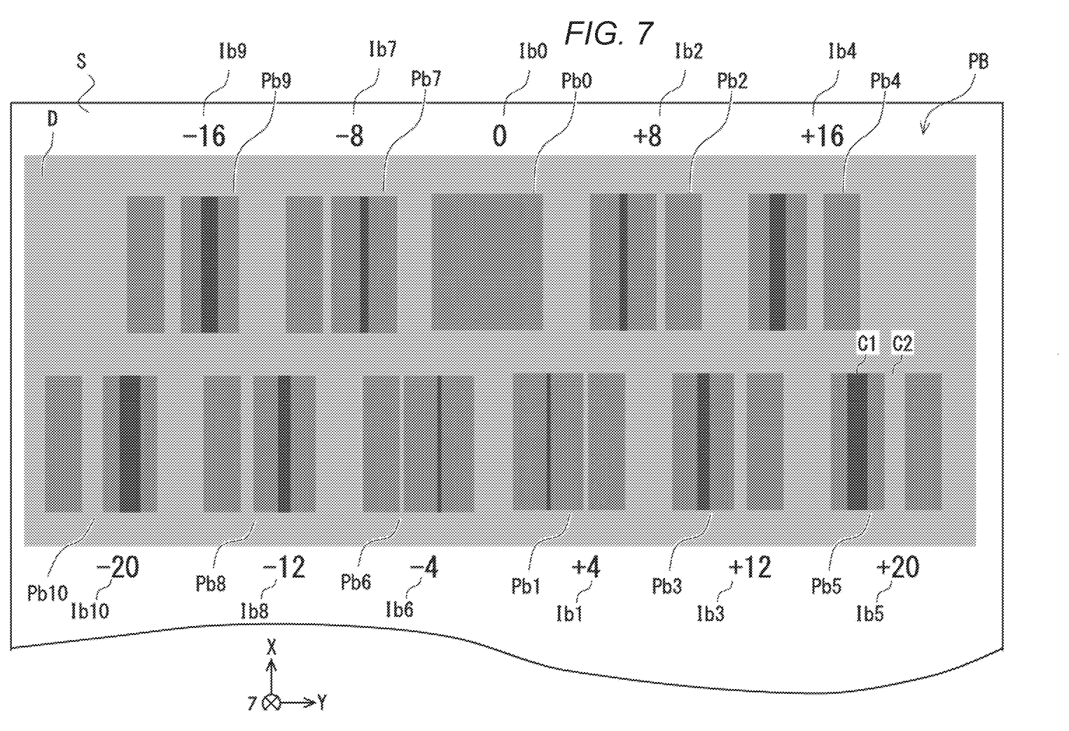

Then, a test pattern to be used for adjusting the landing positions of the second ink (the low-visibility liquid) will be described. FIG. 7 is a schematic diagram illustrating an example of the second test pattern which is the test pattern used for adjusting the landing positions of the second ink (the low-visibility liquid). The print controller 402 controls printing of the second test pattern PB used for adjusting the landing positions of the second ink ejected from the second nozzles on the medium S.

Hereinafter, differences of the second test pattern PB from the first test pattern PA will be described in detail, and description similar to that of the first test pattern PA will be omitted as appropriate. As described above, the first test pattern PA includes the plurality of patterns Pax to be printed while changing the setting value of the adjustment item for adjusting the landing positions of the first ink by the first amount of change. In contrast, the second test pattern PB includes a plurality of patterns (a plurality of patterns Pbx described later) to be printed while changing the setting value of the adjustment item for adjusting the landing positions of the second ink by a second amount of change. More specifically, the first test pattern PA includes the plurality of patterns Pax in which some patches (e.g., the third patch Q3 in FIG. 6) are printed with the setting value of the adjustment item for adjusting the landing positions of the first ink changed by the first amount of change. In contrast, the second test pattern PB includes the plurality of patterns Pbx in which some patches (e.g., the third patch Q3 in FIG. 6) are printed with the setting value of the adjustment item for adjusting the landing positions of the second ink changed by the second amount of change. Here, the adjustment item set when printing the first test pattern PA and the adjustment item set when printing the second test pattern PB are the same, but the amount of change when printing the partial pattern is different between the first test pattern PA and the second test pattern PB. Specifically, the second amount of change described above is larger than the first amount of change described above.

In the case of the first ink (the high-visibility ink), since the contrast of the overlap region C1 or the blank region C2 described above with respect to the background is high, even when the difference in the width of the overlap region C1 or the blank region C2 between the partial patterns is small, it is easy to determine the difference between the partial patterns. In contrast, in the case of the second ink (the low-visibility ink), since the contrast of the overlap region C1 or the blank region C2 with respect to the background is lower than that of the high-visibility ink, it is difficult to determine the difference between the partial patterns when the difference in the width of the overlap region C1 or the blank region C2 between the partial patterns is small. Therefore, in the present embodiment, as described above, in the case of the adjustment of the landing positions of the second ink, the print controller 402 prints the second test pattern PB including the plurality of partial patterns larger in amount of change than in the first test pattern PA used for the adjustment of the landing positions of the first ink. Accordingly, the landing positions of the second ink (the low-visibility ink) can easily be adjusted. Incidentally, in the high-visibility ink, an error in landing positions has a large influence on the image quality. Therefore, it is required to adjust the landing positions of the high-visibility ink with high accuracy. However, since the low-visibility ink has lower visibility than the high-visibility ink, the influence of the landing positions error on the image quality is relatively small. Therefore, such high accuracy adjustment of the landing positions as required for the high-visibility ink is not required for the low-visibility ink. Therefore, in the present embodiment, it can be said that the test pattern suitable for the adjustment of the landing positions of the low-visibility ink can be provided.

As illustrated in FIG. 7, the second test pattern PB that is used for the adjustment of the landing positions of the second ink (the low-visibility ink) includes a plurality of patterns Pb0 to Pb10. Hereinafter, the patterns Pb0 to Pb10 are each referred to as a pattern Pbx when not particularly distinguished from each other. Note that the pattern Pbx is also referred to as a partial pattern. In the example illustrated in FIG. 7, the pattern Pbx is printed using the low-visibility ink on a base image D printed on the medium S using color ink such as black ink. The base image D is an image formed by uniformly ejecting the color ink over a predetermined area. More specifically, the base image D is an image printed by setting an ejection amount of the ink per unit area to a predetermined amount (e.g., 50 % as large as the maximum ejection amount). When the transparent ink (the low-visibility ink) is superimposed on the base image D, the color of a region on which the ink is superimposed in the base image D becomes darker than the color of a region on which the ink is not superimposed in the base image D. This phenomenon becomes remarkable when the transparent ink is further superimposed. Therefore, as illustrated in FIG. 7, the plurality of visible patterns Pbx is formed on the medium S. Note that it is conceivable that the phenomenon described above is caused by the fact that, when the transparent ink is superimposed on the base image D, the color ink in the region on which the ink is superimposed bleeds to increase the dot size of the color ink, and thus the color ink becomes darker. Note that as described above, in the example illustrated in FIG. 7, the second test pattern PB includes the base image D and the plurality of patterns Pbx to be printed on the base image D, but the base image D may be omitted when the pattern Pbx can be visually recognized without the base image D.

In FIG. 7, as an example, the second test pattern PB includes 11 patterns Pbx, but the second test pattern PB is only required to include a plurality of patterns Pbx, and the number of the plurality of patterns Pbx is not limited to 11. Also in the second test pattern PB, the patterns Pbx are arranged apart from each other. In the example illustrated in FIG. 7, in the second test pattern PB, the patterns Pbx are arranged similarly to the first test pattern PA, but the number and arrangement of the partial patterns are not necessarily required to be common to the first test pattern and the second test pattern.

The partial patterns constituting the second test pattern, that is, the patterns Pbx are each also configured with the first patch Q1, the second patch Q2, and the third patch Q3 as illustrated in FIG. 6, similarly to the patterns Pax. The first patch Q1, the second patch Q2, and the third patch Q3 constituting the pattern Pbx are printed by the same printing method as that of the first test pattern PA except that the ink used for printing is different.

As illustrated in FIG. 7, the plurality of patterns Pbx different in position of the third patch Q3 are printed as the second test pattern PB under the control of the print controller 402. Therefore, as shown in the patterns Pb1 to Pb10, the overlap region C1 as a region in which the third patch Q3 overlaps the first patch Q1 or the second patch Q2 and which is printed darkly, and the blank region C2 as a gap between the third patch Q3 and the first patch Q1 or the second patch Q2, are formed on the medium S. As illustrated in the patterns Pb1 to Pb10, the widths of the overlap region C1 and the blank region C2 in the Y-axis direction are different between the patterns Pbx. However, in the second test pattern PB, since the amount of change between the partial patterns is larger than that in the first test pattern PA, the changes in the width in the Y-axis direction of the overlap region C1 and the blank region C2 are larger than those in the first test pattern. Therefore, although the visibility of the partial pattern itself is inferior to that of the first test pattern PA, it is easy to figure out the difference between the partial patterns.

As described above, the patterns Pb0 to Pb10 are patterns printed with the setting value of the adjustment item for adjusting the landing positions of the second ink changed by the second amount of change. The second test pattern PB also includes index values Ib0 to Ib10 representing how much a setting value used for printing each of the patterns Pbx deviates from a predetermined reference value. Hereinafter, the index values Ib0 to Ib10 are each referred to as index value Ibx when not particularly distinguished from each other. Also in the second test pattern PB, the index value Ibx corresponding to the pattern Pbx is printed near the pattern Pbx.

The index value Ibx represents the degree of the amount of change from the predetermined reference value for the setting value used for printing the pattern Pbx. More specifically, similarly to the index value Iax, the index value Ibx represents the number of times as large as a predetermined unit amount the amount of change in the setting value from the predetermined reference value is. In the example shown in FIG. 7, the unit amount used for the index value Ibx is the same as the unit amount used for the index value Iax. Therefore, the unit amount used for the index value Ibx is also an amount of change in the setting value with which the landing positions of the liquid are changed by the predetermined first distance (e.g., 42 μm). As illustrated in FIG. 7, unlike the first test pattern PA illustrated in FIG. 5, the second test pattern PB includes the plurality of patterns Pbx having the index values Ibx different by four. Therefore, every time the index value Ibx increases by four, the landing positions of the liquid are displaced in the +Y direction by four times as large as the predetermined first distance as a result. Similarly, every time the index value Ibx decreases by four, the landing positions of the liquid are displaced in the -Y direction by four times as large as the predetermined first distance. Therefore, it can be said that the second test pattern PB includes a plurality of patterns to be printed while shifting the landing positions of the second ink by a second shift amount (specifically, four times as large as the first distance). More specifically, it can be said that the second test pattern PB includes a plurality of patterns printed while shifting the landing positions of the second ink by the second shift amount (specifically, four times as large as the first distance) with respect to some patches (e.g., the third patch Q3 in FIG. 6). Note that in the example shown in FIG. 7, the unit amount used for the index value Ibx is the same as the unit amount used for the index value Iax, but as described later, the unit amount used for the index value Ibx may be different from the unit amount used for the index value Iax.

In the example illustrated in FIG. 7, some partial patterns of the second test pattern PB are printed in an upper part, and the other partial patterns are printed in a lower part, but the partial patterns are not necessarily printed in a plurality of parts. However, as illustrated in FIG. 7, it is preferable that the partial patterns are arranged such that the index values (the setting values) corresponding thereto are in an ascending or descending order.

When performing the adjustment of the landing positions of the second ink (the low-visibility ink), for example, the user visually observes the printing result of the second test pattern PB as illustrated in FIG. 7 and instructs an appropriate setting value to the printing apparatus 1. Specifically, the user identifies an index value that enables printing in which the position of the third patch Q3 is located at the center of the gap between the first patch Q1 and the second patch Q2 based on the printing result of the second test pattern PB. Then, the user instructs the printing apparatus 1 to execute printing with the setting value corresponding to the identified index value. In this way, the adjustment of the setting value used when ejecting the second ink is achieved. More specifically, in the present embodiment, as an example, the setting value for the ejection of the second ink in the -Y-direction print processing is adjusted. Note that in the example illustrated in FIG. 7, appropriate printing is realized in the pattern Pa0 in which the index value is "0”, but obviously, such a result is not necessarily obtained similarly to the description on the first test pattern. In addition, an intermediate partial pattern between two partial patterns printed as the second test pattern PB may correspond to appropriate printing. The index value identified based on the printing result of the first test pattern for determining the setting value is only required to be a value of an integral multiple of the unit amount described above, and may be an index value not printed in the test pattern. For example, the index values identified based on the printing result of the second test pattern may be "+1”, "+2”, "+3”, "-1”, "-2”, "-3”, and so on. That is, the setting value can be adjusted in units of the unit amount used for the index values Ibx. Here, in the example illustrated in FIG. 7, as described above, the unit amount used for the index value Ibx is the amount of change in the setting value with which the landing positions of the liquid are changed by the predetermined first distance. Therefore, in this example, the setting value for the second ink is determined using the predetermined first distance as a unit of adjustment of the landing positions of the second ink. Therefore, in the example described above, the units of adjustment of the landing positions of the first ink and the second ink are both the first distance and are the same as each other. That is, in this case, the input receiver 401 receives a first input and a second input with the predetermined first distance as a unit of adjustment of the landing positions of the first ink and the second ink as a result. Here, the first input is an input for determining a setting value for the adjustment item of the landing positions for the first ink, and is an input which is input from the user after the first test pattern PA is printed. Further, the second input is an input for determining the setting value for the adjustment item of the landing positions for the second ink, and is an input which is input from the user after the second test pattern PB is printed.

By setting the unit of the adjustment of the landing positions of the second ink (the low-visibility ink) to be the same as the unit of the adjustment of the landing positions of the first ink (the high-visibility ink), the processing can be simplified compared to when the unit of the adjustment of the landing positions of the second ink is changed from the unit of the adjustment of the landing positions of the first ink. For example, regarding the processing of the user interface that receives the input for determining the setting value, the processing of reflecting the setting value on the printing apparatus 1, and so on, it becomes easy to share the processing between the adjustment of the landing positions of the first ink and the adjustment of the landing positions of the second ink. In addition, it is also possible to suppress the capacity of the memory or the like required to realize the processing. Therefore, the manufacturing cost can be suppressed. In addition, by setting the unit of the adjustment of the landing positions of the second ink to be the same as the unit of the adjustment of the landing positions of the first ink, it is possible to finely adjust the landing positions of the second ink similarly to the first ink.

When the input receiver 401 receives the first input, the print controller 402 determines the setting value to be used at the time of printing using the first ink in accordance with the first input. Specifically, the print controller 402 sets the setting value corresponding to the index value designated by the first input as the setting value used at the time of printing using the first ink. Then, the print controller 402 controls printing with the first ink using the setting value determined in accordance with the first input. Similarly, when the input receiver 401 receives the second input, the print controller 402 determines the setting value to be used at the time of printing using the second ink in accordance with the second input. Specifically, the print controller 402 sets the setting value corresponding to the index value designated by the second input as the setting value used at the time of printing using the second ink. Then, the print controller 402 controls printing with the second ink using the setting value determined in accordance with the second input.

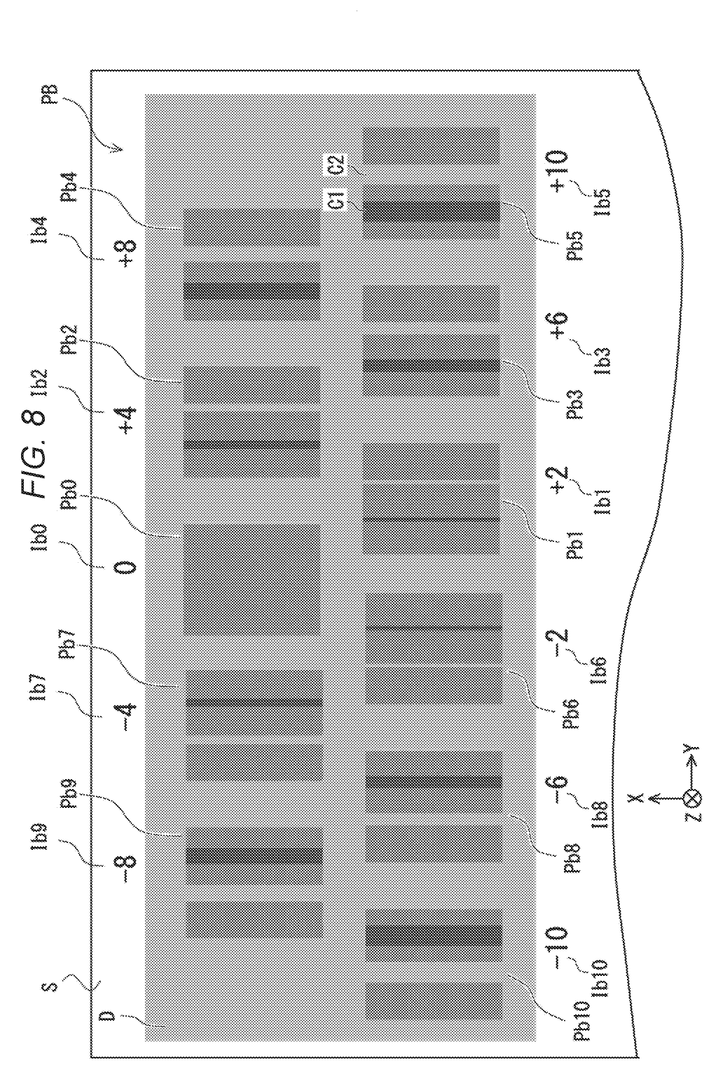

The unit of the adjustment of the landing positions of the second ink (the low-visibility ink) may be different from the unit of the adjustment of the landing positions of the first ink (the high-visibility ink). Specifically, the unit of the adjustment of the landing positions of the second ink may be larger than the unit of the adjustment of the landing positions of the first ink. In this case, the print controller 402 may print the pattern illustrated in FIG. 5 as the first test pattern, and may print, as the second test pattern, the second test pattern PB illustrated in FIG. 8 instead of the test pattern illustrated in FIG. 7. Similarly to the second test pattern PB in FIG. 7, the second test pattern PB in FIG. 8 also includes a plurality of patterns Pbx (patterns Pb0 to Pb10) printed with the setting value of the adjustment item for adjusting the landing positions of the second ink changed by the second amount of change. However, the second test pattern PB in FIG. 8 is different from the second test patterns PB in FIG. 7 in the values of the index values Ibx (index values Ib0 to Ib10) associated with the respective patterns Pbx.

The index value Ibx shown in the second test pattern PB in FIG. 8 also represents the number of times as large as the predetermined unit amount the amount of change in the setting value from the predetermined reference value is. However, in the example shown in FIG. 8, the unit amount used for the index values Ibx is different from the unit amount used for the index values Iax. Specifically, in the example illustrated in FIG. 8, the unit amount used for the index values Ibx is the amount of change in the setting value with which the landing positions of the liquid are changed by the predetermined second distance. Here, as an example, the second distance is twice as large as the first distance (e.g., 42 μm). Therefore, every time the index value Ibx increases by 2, the landing positions of the liquid are displaced in the +Y direction by twice as large as the predetermined second distance, that is, by four times as large as the predetermined first distance as a result. Similarly, every time the index value Ibx decreases by 2, the landing positions of the liquid are displaced in the -Y direction by twice as large as the predetermined second distance, that is, by four times as large as the predetermined first distance as a result.

Here, in the example shown in FIG. 8, the setting value for the second ink is determined with the predetermined second distance as a unit of the adjustment of the landing positions of the second ink. Therefore, in this example, the unit of the adjustment of the landing positions of the first ink is the first distance, whereas the unit of the adjustment of the landing positions of the second ink is the second distance larger than the first distance. That is, in this case, the input receiver 401 receives the first input for determining the setting value for the adjustment item of the landing positions for the first ink with the predetermined first distance as the unit of the adjustment of the landing positions of the first ink. In addition, the input receiver 401 receives a second input for determining a setting value for the adjustment item of the landing positions for the second ink with the predetermined second distance as the unit of the adjustment of the landing positions of the second ink. Accordingly, the landing positions of the second ink (the low-visibility ink) are adjusted in the unit larger than the unit of the adjustment of the landing positions of the first ink (the high-visibility ink).

By making the unit of the adjustment of the landing positions of the second ink (the low-visibility ink) larger than the unit of the adjustment of the landing positions of the first ink (the high-visibility ink), it is possible to adjust the landing positions in units according to the amount of change in the partial pattern in the second test pattern. Therefore, it is possible to suppress the total number of candidates of the input value to be input to the printing apparatus 1 by the user to determine the setting value. That is, since it is sufficient for the user to select an appropriate candidate from a small number of options instead of selecting an appropriate candidate from a large number of options, the convenience of the user is enhanced.

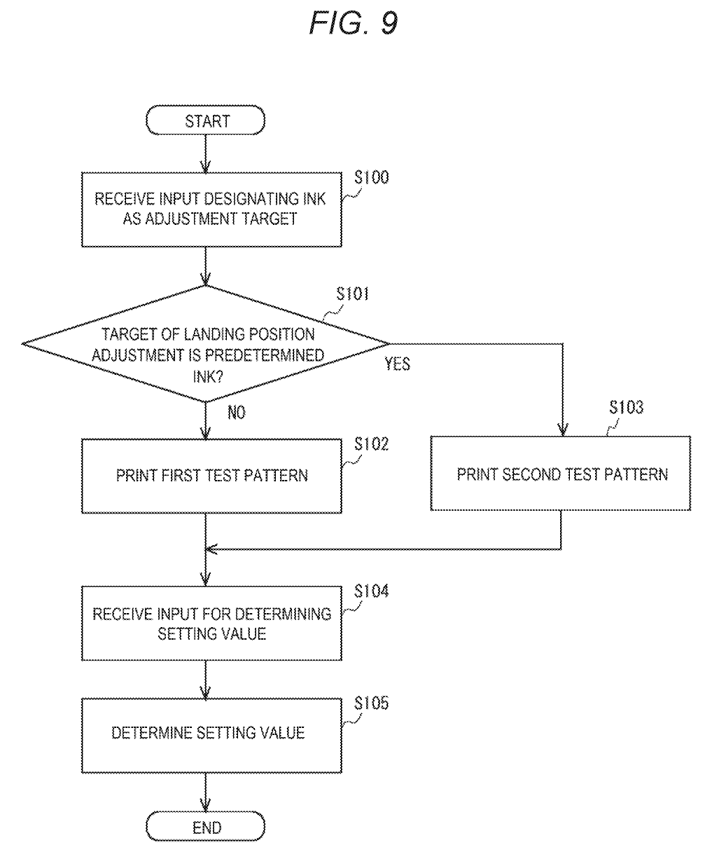

Then, the flow of the operation of the printing apparatus 1 related to the adjustment of the setting value will be described. FIG. 9 is a flowchart illustrating an example of the flow of the operation of the printing apparatus 1 related to the adjustment of the setting value. The flow of the operation of the printing apparatus 1 will hereinafter be described with reference to FIG. 9.

In step S100, the input receiver 401 receives, from the user, an input for designating the ink which is a target of the landing position adjustment.

Then, in step S101, the print controller 402 determines whether the target of the landing position adjustment is the predetermined ink. Here, the predetermined ink is the second ink (the low-visibility ink) described above, and is specifically a penetrant in the present embodiment. When the target of the landing position adjustment is not the predetermined ink, that is, when the target of the landing position adjustment is the first ink (the high-visibility ink), the process proceeds to step S102. In contrast, when the target of the landing position adjustment is the predetermined ink, that is, when the target of the landing position adjustment is the second ink (the low-visibility ink), the process proceeds to step S103.

When the process proceeds to step S102, the print controller 402 prints the first test pattern PA described above on the medium S. In contrast, when the process proceeds to step S103, the print controller 402 prints the second test pattern PB described above on the medium S. In step S100, both the first ink and the second ink may be designated as the target of the landing position adjustment, and in this case, the print controller 402 prints the first test pattern PA and the second test pattern PB on the medium S. When the test pattern is printed, the process proceeds to step S104.

In step S104, the input receiver 401 receives an input for determining the setting value from the user who has confirmed the test pattern.

Then, in step S105, the print controller 402 determines the setting value for the ejection of the ink as the target of the adjustment in accordance with the input received in step S104. That is, thereafter, when printing any image using that ink, the print controller 402 ejects that ink in accordance with the setting value thus determined as a result.

Embodiment 1 has been described hereinabove. According to the present embodiment, when adjusting the landing positions of the second ink (the low-visibility ink), the second test pattern including the plurality of partial patterns larger in amount of change than in the first test pattern used for adjusting the landing positions of the first ink (the high-visibility ink) is printed. Accordingly, even when the target of the adjustment is the second ink (the low-visibility ink), the landing positions can easily be adjusted.

Further, in the present embodiment, a specific example of the second ink (the low-visibility ink) is a penetrant. Since the penetrant is a functional liquid that reacts with the color ink, it is sufficient to eject the penetrant so as to cover an area that is somewhat larger than the area in which the color ink lands, and such an accurate landing position adjustment as in the color ink is not required. Therefore, when the second ink (the low-visibility ink) is the penetrant, even when the landing positions of the second ink are adjusted by the technique described above, it can be said that there is almost no harmful influence on the image quality.

Note that in the present embodiment, the penetrant is cited as a specific example of the second ink (the low-visibility ink), but the second ink may be another transparent functional liquid. In addition, the second ink is only required to be ink having low visibility when ejected onto the medium S, and is not required to be a transparent liquid. For example, the second ink may be a colored liquid whose a color difference from a color (e.g., white) of the predetermined medium S is identified in advance to be less than a predetermined threshold value.

### Embodiment 2

The visibility of ink is affected by a color difference between the medium S and the ink. Therefore, in the embodiment described above, when the color of the medium S on which the test pattern is printed is unknown, there is a concern that the first test pattern or the second test pattern may be applied to inappropriate ink. Therefore, in the present embodiment, there will be described a technique which is capable of selecting a test pattern suitable for ink by determining whether the ink which is the target of the landing position adjustment is the high-visibility ink or the low-visibility ink based on the color of the medium S.

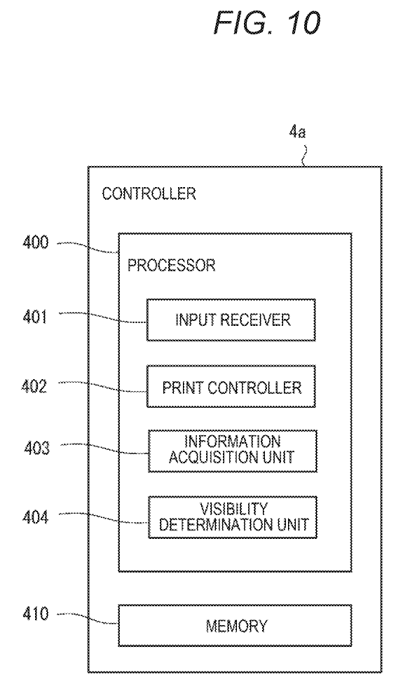

FIG. 10 is a block diagram showing an example of a configuration of a controller 4a according to the present embodiment. The present embodiment is different from Embodiment 1 in that the controller 4 is replaced with the controller 4a. The controller 4a is different from the controller 4 illustrated in FIG. 4 in that the controller 4a further includes an information acquisition unit 403 and a visibility determination unit 404. The functions of the information acquisition unit 403 and the visibility determination unit 404 are also realized by, for example, the processor 400 reading a program from the memory 410 and executing the program. Hereinafter, differences from Embodiment 1 will be described, and descriptions of configurations, processes, and so on overlapping those of Embodiment 1 will be omitted as appropriate.

The information acquisition unit 403 acquires medium information of the medium S on which the test pattern is printed. The medium information may be information that identifies the color of the medium S, and is not limited to information that directly represents the color of the medium S, and may be information that indirectly represents the color of the medium S. For example, when identification information of the medium and color information of the medium are stored in the memory 410 or the like in association with each other, the information acquisition unit 403 may acquire the identification information of the medium S as the medium information. The information acquisition unit 403 may acquire the medium information input from the user, that is, the medium information received by the input receiver 401, or may acquire the color information of the medium S detected by a sensor (e.g., a scanner or a camera) communicably coupled to the printing apparatus 1.

The visibility determination unit 404 determines which one of the first ink (the high-visibility ink) and the second ink (the low-visibility ink) corresponds to target ink that is the ink as the target of the landing position adjustment by comparing the color of the target ink with the color of the medium S identified from the medium information acquired by the information acquisition unit 403. For example, when the color difference between the color of the target ink and the color of the medium S is equal to or greater than a predetermined threshold value, the visibility determination unit 404 determines that the target ink is the first ink (the high-visibility ink). In contrast, when the color difference between the color of the target ink and the color of the medium S is less than the predetermined threshold value, the visibility determination unit 404 determines that the target ink is the second ink (the low-visibility ink). Note that the color information of each ink that can be ejected by the printing apparatus 1 is stored in advance in the memory 410 or the like, and the visibility determination unit 404 identifies the color of the target ink by referring to the color information of the target ink stored in advance. Further, the color difference is defined by, for example, a distance in a color space using the Lab color system, but may be defined by a distance in a color space in the RGB color system.

Further, in the present embodiment, when the visibility determination unit 404 determines that the target ink corresponds to the first ink (the high-visibility ink), the print controller 402 executes printing of the first test pattern described above on the medium S using the target ink. In contrast, when the visibility determination unit 404 determines that the target ink corresponds to the second ink (the low-visibility ink), the print controller 402 executes printing of the second test pattern described above on the medium S using the target ink.

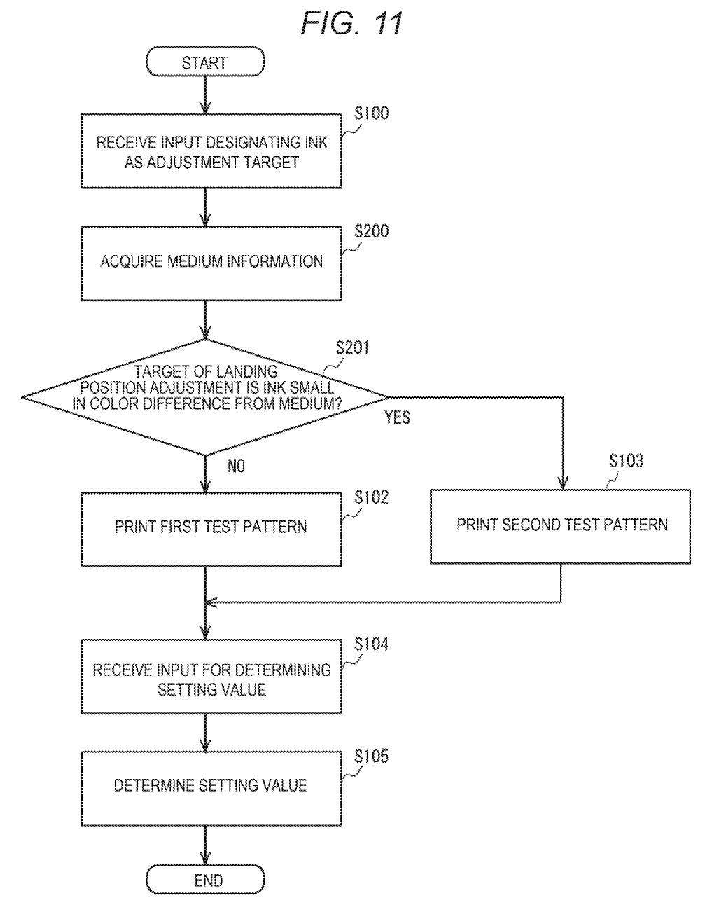

Then, an operation flow of the printing apparatus 1 according to the present embodiment will be described. FIG. 11 is a flowchart showing an example of a flow of an operation of the printing apparatus 1 according to Embodiment 2. Differences from the flowchart shown in FIG. 9 will hereinafter be described, and the redundant description will be omitted as appropriate. The flowchart illustrated in FIG. 11 is different from the flowchart illustrated in FIG. 9 in that step S101 in FIG. 9 is replaced with step S200 and step S201.

In the present embodiment, in step S100, when the input receiver 401 receives an input for designating the ink (that is, the target ink) as the target of the landing position adjustment from the user, the process proceeds to step S200.

In step S200, the information acquisition unit 403 acquires the medium information of the medium S. That is, the information acquisition unit 403 acquires information for identifying the color of the medium S. After step S200, the process proceeds to step S201.

In step S201, the visibility determination unit 404 determines whether the target ink designated in step S100 corresponds to the first ink (the high-visibility ink) or the second ink (the low-visibility ink) based on the color of the target ink and the color of the medium S identified in step S200. When the target ink is an ink having a small color difference from the medium S, that is, when the color difference between the color of the target ink and the color of the medium S identified in step S200 is less than the threshold value, the target ink is determined to be the second ink (the low-visibility ink). In this case, the process proceeds to step S103. In contrast, when the target ink is the ink having a large color difference from the medium S, that is, when the color difference between the color of the target ink and the color of the medium S is equal to or greater than the threshold value, the target ink is determined to be the first ink (the high-visibility ink). In this case, the process proceeds to step S102. Since the processing after proceeding to step S102 or step S103 is substantially the same as in the flowchart illustrated in FIG. 9, the description thereof will be omitted.

Embodiment 2 has been described hereinabove. According to the present embodiment, whether the target ink is the high-visibility ink or the low-visibility ink is determined based on the color of the medium S on which the test pattern is printed. Therefore, even when the color of the medium S on which the test pattern is printed is unknown in advance, the first test pattern and the second test pattern can selectively be used in an appropriate manner. Therefore, it is possible to appropriately apply the second test pattern to ink, such as opaque ink, visibility of which significantly depends on the color of the medium S.

Embodiment 1 and Embodiment 2 have been described above, but the present disclosure is not limited to the embodiments described above and can be modified as appropriate without departing from the gist of the present disclosure. For example, in the embodiments described above, the user visually confirms the printing result of the first test pattern or the second test pattern and then performs an input for determining an appropriate setting value. However, the appropriate setting value may be determined by performing image analysis processing with a computer on an image obtained by reading, with a scanner or the like, the medium on which the test pattern is printed. Therefore, in the present disclosure, the visibility can mean not only whether it is easy for human eyes to visually recognize, but also whether it is easy for a sensor to detect.

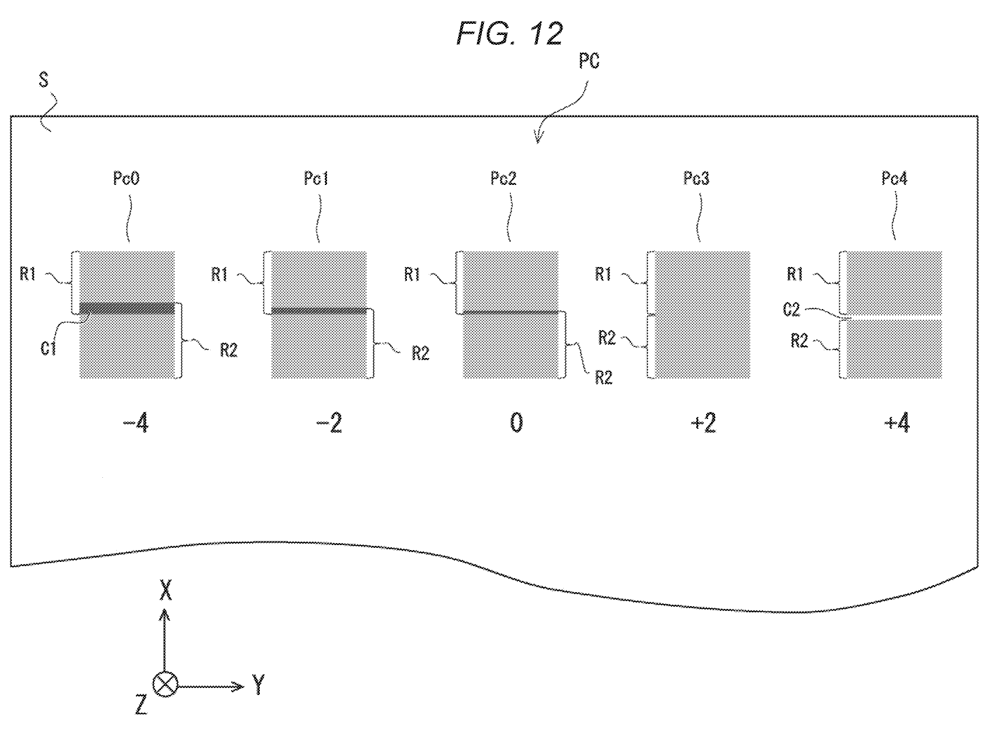

Further, in the embodiments described above, the print controller 402 selectively uses two types of test patterns (the first test pattern and the second test pattern) as the test pattern used for adjusting the landing positions of the ink in a moving direction (the Y-axis direction) of the head unit U. However, the print controller 402 may selectively use two types of test patterns for adjusting the landing positions of the ink in the conveyance direction (the X-axis direction) of the medium S. For example, the print controller 402 may print a test pattern PC as illustrated in FIG. 12 as the test pattern for adjusting the landing positions of the ink in the conveyance direction (the X-axis direction) of the medium S.

FIG. 12 is a schematic diagram illustrating an example of the test pattern for adjusting the landing positions of the ink in the conveyance direction (the X-axis direction) of the medium S. As shown in FIG. 12, the test pattern PC includes a plurality of patterns Pc0 to Pc4. Hereinafter, the patterns Pc0 to Pc4 are each referred to as a pattern Pcx when not particularly distinguished from each other. In FIG. 12, as an example, the test pattern PC includes the five patterns Pcx, but is only required to include a plurality of patterns Pcx, and the number of patterns Pcx is not limited to five.

The pattern Pcx is formed of a first patch R1 and a second patch R2. Here, the first patch R1 is a patch printed during a first movement of the head unit U, and the second patch R2 is a patch printed during a second movement of the head unit U. Here, the second movement is performed after the conveyance of the medium S performed after the first movement. Note that the first patch R1 may be a patch printed by one of the two adjacent head chips Hc contained in the liquid ejection head H, and the second patch R2 may be a patch printed by the other of the head chips Hc. The print controller 402 prints the plurality of patterns Pcx having the respective second patches R2 shifted in position from each other by changing the number of nozzles used when printing the respective second patches R2. More specifically, the print controller 402 prints various patterns Pcx by changing, between the patterns Pcx, the number of nozzles made unavailable from the end in the X-axis direction in the nozzle array. As a result, the patterns Pcx having the overlap region C1 or the blank region C2 with various widths are printed. The print controller 402 prints the test pattern while changing a displacement of the second patch R2 by the pattern Pcx in accordance with whether the target of the landing position adjustment is the first ink (the high-visibility ink) or the second ink (the low-visibility ink). That is, when the target of the landing position adjustment is the first ink (the high-visibility ink), the print controller 402 prints a plurality of patterns with the landing positions of the first ink for the second patch R2 displaced by a first displacement. Further, when the target of the landing position adjustment is the second ink (the low-visibility ink), the print controller 402 prints a plurality of patterns with the landing positions of the second ink for the second patch R2 displaced by a second displacement larger than the first displacement. Note that in the example described above, the setting value of the adjustment item for adjusting the landing positions in the X-axis direction is the number of nozzles that are not used at the time of printing, but the conveyance amount of the medium S may be used as the setting value of the adjustment item for adjusting the landing positions in the X-axis direction. In this case, the plurality of patterns Pcx may be printed so as to be arranged side by side in the X-axis direction.

Further, in the present disclosure, the program includes a command group (or software codes) for causing a computer to perform one or more functions described in the embodiments when the program is read by the computer. The program may be stored in a non-transitory computer-readable medium or a tangible storage medium. Not as a limitation but as an example, the computer-readable medium or the tangible storage medium includes a random-access memory (RAM), a read-only memory (ROM), a flash memory, a solid-state drive (SSD), or other memory techniques, a CD-ROM, a digital versatile disk (DVD), a Blu-ray (registered trademark) disk, or other optical disc storages, and a magnetic cassette, a magnetic tape, and a magnetic disk storage, or other magnetic storage devices. The program may be transmitted on a transitory computer-readable medium or a communication medium. Not as a limitation but as an example, the transitory computer-readable medium or the communication medium includes an electrical propagation signal, an optical propagation signal, an acoustic propagation signal, or propagation signals of other forms.

A part or the whole of the embodiments or the modifications described above can also be described as the following appendices but is not limited to the following.

### Appendix 1

A printing apparatus including:

a print head unit including a plurality of first nozzles configured to eject first ink to a medium and a plurality of second nozzles configured to eject, to the medium, second ink lower in visibility than the first ink; and

a print controller configured to control printing using the print head unit, wherein

the print controller controls execution of at least one of printing of a first test pattern used for adjusting a landing position on the medium of the first ink ejected from the first nozzle, and printing of a second test pattern used for adjusting a landing position on the medium of the second ink ejected from the second nozzle,

the first test pattern includes a plurality of patterns to be printed with a setting value of an adjustment item for adjusting the landing position of the first ink changed by a first amount of change,

the second test pattern includes a plurality of patterns to be printed with a setting value of an adjustment item for adjusting the landing position of the second ink changed by a second amount of change, and

the second amount of change is larger than the first amount of change.

### Appendix 2

The printing apparatus according to Appendix 1, wherein

the second ink is a penetrant configured to promote permeation of the first ink into the medium.

### Appendix 3

The printing apparatus according to Appendix 1 or 2, wherein

the second ink is transparent.

### Appendix 4

The printing apparatus according to any one of Appendices 1 to 3, further including:

an information acquisition unit configured to acquire medium information which is information for identifying a color of the medium; and

a visibility determination unit configured to determine which one of the first ink and the second ink corresponds to a target ink which is ink as a target of a landing position adjustment by comparing a color of the target ink with a color of the medium identified from the medium information, wherein

when the visibility determination unit determines that the target ink corresponds to the first ink, the print controller executes the printing of the first test pattern on the medium, and

when the visibility determination unit determines that the target ink corresponds to the second ink, the print controller executes the printing of the second test pattern on the medium.

### Appendix 5

The printing apparatus according to any one of Appendices 1 to 4, further including

an input receiver configured to receive a first input for determining a setting value to the adjustment item for the first ink and a second input for determining a setting value to the adjustment item for the second ink with a predetermined distance as a unit of adjustment of landing positions of the first ink and the second ink, wherein

the print controller controls printing with the first ink using the setting value determined in accordance with the first input and controls printing with the second ink using the setting value determined in accordance with the second input.

### Appendix 6

The printing apparatus according to any one of Appendices 1 to 4, further including

an input receiver configured to receive a first input for determining a setting value to the adjustment item for the first ink with a predetermined first distance as a unit of adjustment of landing position of the first ink, and a second input for determining a setting value to the adjustment item for the second ink with a predetermined second distance as a unit of adjustment of landing position of the second ink, wherein

the print controller controls printing with the first ink using the setting value determined in accordance with the first input and controls printing with the second ink using the setting value determined in accordance with the second input, and

the second distance is larger than the first distance.

### Appendix 7

A printing method executed by a printing apparatus including a print head unit including a plurality of first nozzles configured to eject first ink to a medium and a plurality of second nozzles configured to eject, to the medium, second ink lower in visibility than the first ink, the method including

performing printing of a test pattern including at least one of printing of a first test pattern used for adjusting a landing position on the medium of the first ink ejected from the first nozzle, and printing of a second test pattern used for adjusting a landing position on the medium of the second ink ejected from the second nozzle, wherein

the first test pattern includes a plurality of patterns to be printed with a setting value of an adjustment item for adjusting the landing position of the first ink changed by a first amount of change,

the second test pattern includes a plurality of patterns to be printed with a setting value of an adjustment item for adjusting the landing position of the second ink changed by a second amount of change, and

the second amount of change is larger than the first amount of change.

What is claimed is:

1. A printing apparatus comprising:
a print head unit including a plurality of first nozzles configured to eject first ink to a medium and a plurality of second nozzles configured to eject, to the medium, second ink lower in visibility than the first ink; and
a print controller configured to control printing using the print head unit, wherein
the print controller controls execution of at least one of printing of a first test pattern used for adjusting a landing position on the medium of the first ink ejected from the first nozzle, and printing of a second test pattern used for adjusting a landing position on the medium of the second ink ejected from the second nozzle,
the first test pattern includes a plurality of patterns to be printed with a setting value of an adjustment item for adjusting the landing position of the first ink changed by a first amount of change,
the second test pattern includes a plurality of patterns to be printed with a setting value of an adjustment item for adjusting the landing position of the second ink changed by a second amount of change, and
the second amount of change is larger than the first amount of change.

2. The printing apparatus according to claim 1, wherein
the second ink is a penetrant configured to promote permeation of the first ink into the medium.

3. The printing apparatus according to claim 1, wherein
the second ink is transparent.

4. The printing apparatus according to claim 1, further comprising:
an information acquisition unit configured to acquire medium information which is information for identifying a color of the medium; and
a visibility determination unit configured to determine which one of the first ink and the second ink corresponds to a target ink which is ink as a target of a landing position adjustment by comparing a color of the target ink with a color of the medium identified from the medium information, wherein
when the visibility determination unit determines that the target ink corresponds to the first ink, the print controller executes the printing of the first test pattern on the medium, and
when the visibility determination unit determines that the target ink corresponds to the second ink, the print controller executes the printing of the second test pattern on the medium.

5. The printing apparatus according to claim 1, further comprising
an input receiver configured to receive a first input for determining a setting value to the adjustment item for the first ink and a second input for determining a setting value to the adjustment item for the second ink with a predetermined distance as a unit of adjustment of landing positions of the first ink and the second ink, wherein
the print controller controls printing with the first ink using the setting value determined in accordance with the first input and controls printing with the second ink using the setting value determined in accordance with the second input.

6. The printing apparatus according to claim 1, further comprising
an input receiver configured to receive a first input for determining a setting value to the adjustment item for the first ink with a predetermined first distance as a unit of adjustment of landing position of the first ink, and a second input for determining a setting value to the adjustment item for the second ink with a predetermined second distance as a unit of adjustment of landing position of the second ink, wherein
the print controller controls printing with the first ink using the setting value determined in accordance with the first input and controls printing with the second ink using the setting value determined in accordance with the second input, and
the second distance is larger than the first distance.

7. A printing method executed by a printing apparatus including a print head unit including a plurality of first nozzles configured to eject first ink to a medium and a plurality of second nozzles configured to eject, to the medium, second ink lower in visibility than the first ink, the method comprising
performing printing of a test pattern including at least one of printing of a first test pattern used for adjusting a landing position on the medium of the first ink ejected from the first nozzle, and printing of a second test pattern used for adjusting a landing position on the medium of the second ink ejected from the second nozzle, wherein
the first test pattern includes a plurality of patterns to be printed with a setting value of an adjustment item for adjusting the landing position of the first ink changed by a first amount of change,
the second test pattern includes a plurality of patterns to be printed with a setting value of an adjustment item for adjusting the landing position of the second ink changed by a second amount of change, and
the second amount of change is larger than the first amount of change.
